(19) United States
(12) Patent Application Publication
(10) Pub. No.: US 2008/0280146 A1
(43) Pub. Date: Nov. 13, 2008

(54) Pre-cut wafer structure with heat stress effect suppressed

(75) Inventors: Wu Chih-Hung, Longtan Shiang (TW); Chang Kai-Sheng, Longtan Shiang (TW); Chu Kuan-Yu, Longtan Shiang (TW)

Correspondence Address: TROXELL LAW OFFICE PLLC, 5205 LEESBURG PIKE, SUITE 1404, FALLS CHURCH, VA, 22041, US

(73) Assignee: ATOMIC ENERGY COUNCIL - INSTITUTE OF NUCLEAR ENERGY RESEARCH, Taoyuan (TW)

(21) Appl. No.: 11/798,315

(22) Filed: May 11, 2007

(51) Int. Cl. B32B 9/04; B32B 15/04; B32B 17/06

(52) U.S. Cl. 428/426; 428/411.1; 428/446; 428/457

(57) ABSTRACT

A wafer is cut before a heat treatment. By the cutting, cutting lines are not bended after the heat treatment. A cutting accuracy is therefore improved and a good light-shining efficiency is obtained.

### FIELD OF THE INVENTION

The present invention relates to a wafer structure; more particularly, relates to preventing cutting lines from being bended by an accumulated stress and obtaining good cutting accuracy and light-shining efficiency.

### DESCRIPTION OF THE RELATED ART

A wafer has a great sum of integrated circuits (IC). After fabricating the ICs or obtaining a concaved wafer, the wafer is cut into a plurality of chips and the wafer is usually cut before a heat treatment. Yet, after the heat treatment, the wafer may be bended owing to a heat stress effect; and the bigger diameter the wafer has, the wafer is bended more obviously. As a result, the accuracy of the cutting lines is greatly affected in the cutting process after the heat treatment; and thus light-shining efficiency becomes bad with product reliability reduced.

As shown in FIG. 6 and FIG. 7, the prior art deposes a glass substrate 130 on a wafer 140 and processes a cutting to the glass substrate 130, where the glass substrate 130 and the wafer 140 are separated by a pad 150. Because an operator can clearly see the arrangement of single chips 144 on an active surface 142 of the wafer 140 through the glass substrate 130, the glass substrate 130 is cut to obtain a plurality of substrate cutting lines 132 by shifting a default distance according to a side length of the single chip 144.

However, the wafer 140 has to be turned over for cutting from its back surface 146 without damaging the glass substrate 130. Because the arrangement of the single chips are not seen from the back surface 146 on cutting the wafer, a vertical base line 162 and a horizontal base line 172 have to be cut on the back surface 146 in advance. Then, the wafer 140 is cut in the back surface 146 based on the vertical base line 162 and the horizontal base line 172 to form a plurality of vertical cutting lines 164 and a plurality of horizontal cutting lines 174 for separating the single chips 144. In detail, on cutting the wafer 140, a vertical cutting line 164a is decided by shifting a cutting device at a distance of the side length of the single chip 144 based on a previous vertical cutting line 164b; and, in the same way, a horizontal cutting line 174a is decided by shifting the cutting device at a distance of the side length of the single chip 144 based on a previous horizontal cutting line 174b as well.

Nevertheless, the process of forming a vertical cutting line and a horizontal cutting line based on a previous vertical cutting line and a previous horizontal cutting line may cause deviations owing to a slanting angle obtained on shifting the cutting device and a shifting distance error. Moreover, the wafer may be bended owing to a heat stress effect after the heat treatment. And, when cutting the vertical cutting line or the horizontal cutting line, the cutting is not only affected by the slanting angle and the shifting distance error, but also by the bending of the wafer for not capable of sharply aiming at the cutting lines. Consequently, after cutting the wafer to obtain vertical cutting lines and horizontal cutting lines, a big accumulated slanting angle, a great accumulated shifting distance error and an enormous accumulated fault on cutting accuracy may be resulted in to make chip fail or light-shining effect bad with product reliability reduced. Hence, the prior art does not fulfill all users' requests on actual use.

### SUMMARY OF THE INVENTION

The main purpose of the present invention is to have a cutting process down to one tenth thickness of a substrate before a heat treatment for preventing cutting lines from being bended by an accumulated stress and obtaining good cutting accuracy and light-shining efficiency.

To achieve the above purpose, the present invention is a p re-cut wafer structure with heat stress effect suppressed, comprising an epitaxy layer and a substrate, where the epitaxy layer has a plurality of vertical epitaxy saw marks and a plurality of horizontal epitaxy saw marks; the vertical epitaxy saw marks and the horizontal epitaxy saw marks are perpendicular to each others; the vertical and the horizontal epitaxy saw marks are extended to an edge of the substrate; a plurality of chips are defined by a plurality of geometric are as each surrounded by a pair of the neighboring vertical epitaxy saw marks and a pair of the neighboring horizontal epitaxy saw marks; and the substrate is connected with the epitaxy layer to be processed with a cutting process down to one tenth thickness of the substrate with the vertical epitaxy saw marks and the horizontal epitaxy saw marks before a heat treatment. Accordingly, a novel pre-cut wafer structure with heat stress effect suppressed is obtained.

### BRIEF DESCRIPTIONS OF THE DRAWINGS

The present invention will be better understood from the following detailed description of the preferred embodiment according to the present invention, taken in con junction with the accompanying drawings, in which

FIG. 1 is the vertical sectional view showing the preferred embodiment according to the present invention;

FIG. 2 is the horizontal sectional view showing the preferred embodiment;

FIG. 3 is the view showing the surface of the preferred embodiment;

FIG. 4 is the perspective view showing the pre-cut wafer;

FIG. 5 is the view showing the base level for cutting the wafer;

FIG. 6 is the sectional view of the prior art; and

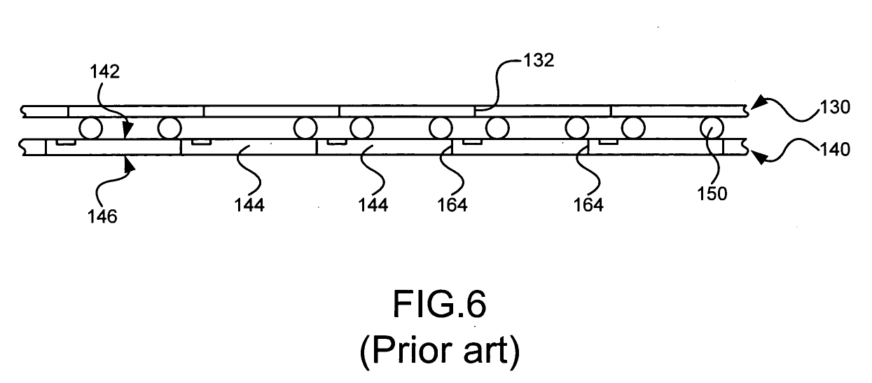

FIG. 7 is the back-surface view of the prior art.

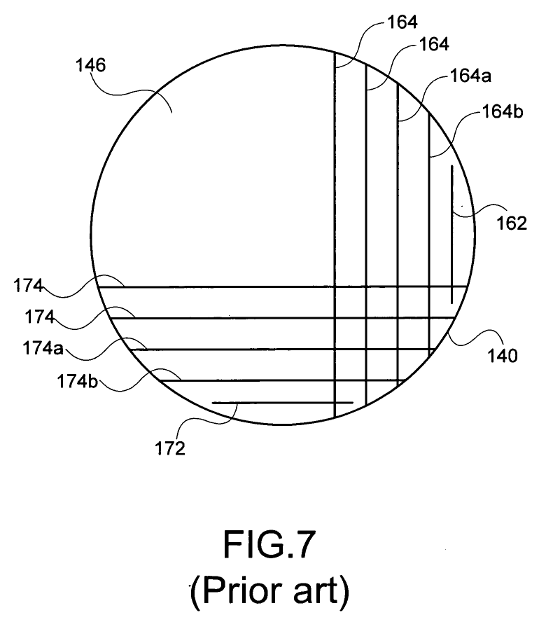

### DESCRIPTION OF THE PREFERRED EMBODIMENT

The following description of the preferred embodiment is provided to understand the features and the structures of the present invention.

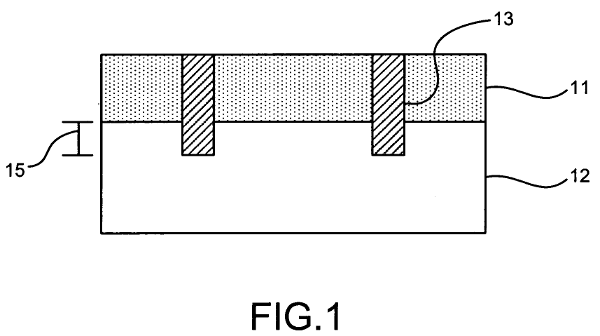

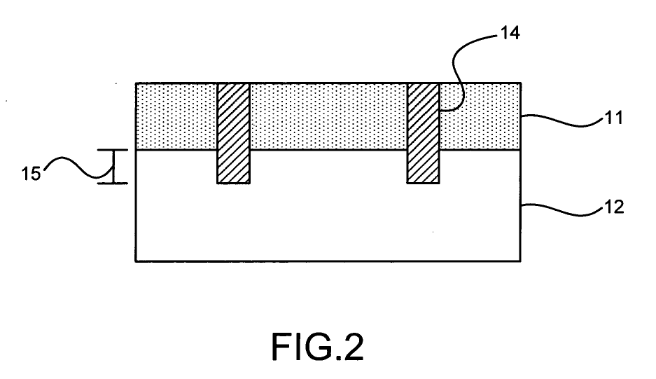

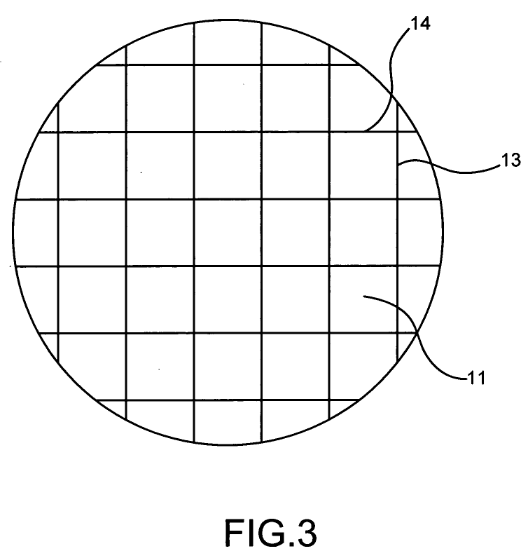

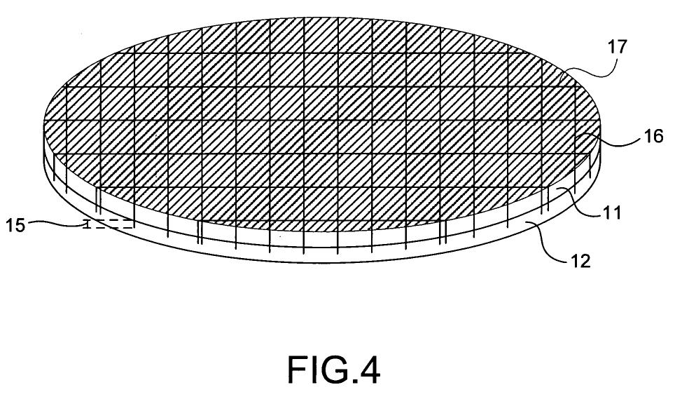

Please refer to FIG. 1 to FIG. 4, which are a vertical and a horizontal sectional view showing a preferred embodiment according to the present invention; a view showing a surface of the preferred embodiment; and a perspective view showing the pre-cut wafer. As shown in the figures, the present invention is a pre-cut wafer structure with heat stress effect suppressed, comprising an epitaxy layer 11 and a substrate 12, where a precision of a wafer cutting is effectively improved.

The epitaxy layer 11 has a plurality of vertical epitaxy saw marks 13 and a plurality of horizontal epitaxy saw marks 14, where each vertical epitaxy saw mark is perpendicular to each horizontal epitaxy saw mark; the vertical epitaxy saw marks 13 and the horizontal epitaxy saw marks 14 are extended to an edge of the substrate; a plurality of chips is defined by a plurality of geometric areas each surrounded by a pair of the neighboring vertical epitaxy saw marks 13 and a pair of the neighboring horizontal epitaxy saw marks 14; and the epitaxy layer 11 is a light-emitting device or a light-absorbing device.

The substrate 12 is connected with the epitaxy layer 11 and is processed with a cutting process down to a depth of one tenth thickness of the substrate 15 with the vertical epitaxy saw marks 13 and the horizontal epitaxy saw marks 14, where 20% error in the depth is allowed. Therein, the substrate 12 is a glass substrate, a sapphire substrate, a germanium-based substrate, a gallium arsenide (GaAs) substrate or a silicon substrate; the cutting process is an etching process or a cutting process; and the etching process is a physical etching process or a chemical etching process.

When using the present invention, the substrate 12 is connected with the epitaxy layer 11. The epitaxy layer 11 has the plurality of vertical epitaxy saw marks 13 and the plurality of horizontal epitaxy saw marks 14; and the vertical epitaxy saw marks 13 and the horizontal epitaxy saw marks 14 are on a surface of the epitaxy layer 11. Each vertical epitaxy saw mark 13 is perpendicular to each horizontal epitaxy saw mark 14. And a plurality of chips are defined by a plurality of geometric areas each surrounded by a pair of neighboring vertical epitaxy saw marks 13 and a pair of neighboring horizontal epitaxy saw marks 14.

Then, a cutting process is processed with the vertical epitaxy saw marks 13 and the horizontal epitaxy saw marks 14 before a heat treatment and the vertical epitaxy saw marks 13 and the horizontal epitaxy saw marks 14 are used as base lines to cut the substrate 12. Therein, the cutting is processed down to one tenth thickness 15 of the substrate 12 to obtain a plurality of vertical substrate cutting lines 16 and a plurality of horizontal substrate cutting lines 17; each vertical substrate cutting line 16 is perpendicular to each horizontal substrate cutting line 17; and, the vertical substrate cutting lines 16 and the horizontal substrate cutting lines 17 are extended to an edge of the substrate 12.

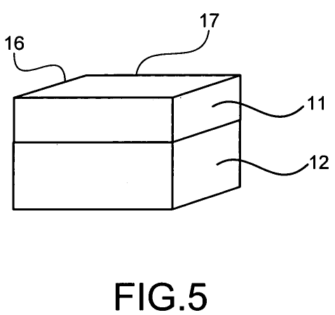

Please refer to FIG. 5, which is a view showing a base level for cutting a wafer. As shown in the figure, during a heat treatment, a substrate cutting line is bended and a cutting accuracy of the following process is thus hindered. When a substrate has a bigger diameter, the bending gets more severe owing to an accumulated stress; and a light-shining efficiency be comes worse. The present invention cuts a wafer before a heat treatment to prevent vertical substrate cutting lines 16 and horizontal substrate cutting lines 17 from being bended and accuracy errors of the cutting lines are thus reduced in the following processes to the substrate 12.

To sum up, the present invention is a pre-cut wafer structure with heat stress effect suppressed, where a cutting process is processed before a heat treatment with a depth down to one tenth thickness of a substrate so that errors of cutting lines owing to an accumulated stress in the heat treatment are reduced to obtain improved cutting accuracy for following processes and thus a good light-shining efficiency.

The preferred embodiment(s) herein disclosed is/are not intended to unnecessarily limit the scope of the invention. Therefore, simple modifications or variations belonging to the equivalent of the scope of the claims and the instructions disclosed herein for a patent are all within the scope of the present invention.

1. A pre-cut wafer structure with heat stress effect suppressed, comprising:
an epitaxy layer, said epitaxy layer having a plurality of vertical epitaxy saw marks and a plurality of horizontal epitaxy saw marks; and
a substrate, said substrate being connected with said epitaxy layer, said substrate being processed through a cutting process with said vertical epitaxy saw marks and said horizontal epitaxy saw marks before a heat treatment effectuating a chemical change in the substrate, said cutting process having a processing depth down to one tenth of a thickness of said substrate with an error allowance smaller than 20 percent to form the pre-cut wafer structure with heat stress effect suppressed.

2. The structure according to claim 1, wherein each of said vertical epitaxy saw marks is perpendicular to each of said horizontal epitaxy saw marks.

3. The structure according to claim 1, wherein said vertical epitaxy saw marks and said horizontal epitaxy saw marks are extended to an edge of said substrate.

4. The structure according to claim 1, wherein a plurality of chips is obtained on said substrate; and
wherein each said chip is obtained by a geometric area surrounded by a pair of two neighboring said vertical epitaxy saw marks and a pair of two neighboring said horizontal epitaxy saw marks.

5. The structure according to claim 1, wherein said cutting process is selected from a group consisting of an etching process and a cutting process.

6. The structure according to claim 5, wherein said etching process is selected from a group consisting of a physical etching process and a chemical etching process.

7. The structure according to claim 1, wherein said epitaxy layer is selected from a group consisting of a light-emitting device and a light-absorbing device.

8. The structure according to claim 1, wherein said substrate is selected from a group consisting of a glass substrate, a sapphire substrate, a germanium-based substrate, a gallium arsenide (GaAs) substrate and a silicon substrate.
